(19) United States
(12) Patent Application Publication
(10) Pub. No.: US 2019/0156204 A1
(43) Pub. Date: May 23, 2019

(54) TRAINING A NEURAL NETWORK MODEL

(71) Applicant: KONINKLIJKE PHILIPS N.V., Eindhoven (NL)

(72) Inventors: Erik Bresch, Eindhoven (NL); Ulf Grossekathöfer, Eindhoven (NL)

(21) Appl. No.: 16/188,835

(22) Filed: Nov. 13, 2018

Related U.S. Application Data
(60) Provisional application No. 62/588,575, filed on Nov. 20, 2017.

(51) Int. Cl. G06N 3/08; G06N 3/04

(52) U.S. Cl. CPC G06N 3/08; G06N 3/04

(57) ABSTRACT

A system for training a neural network model, comprises a memory comprising instruction data representing a set of instructions and a processor configured to communicate with the memory and to execute the set of instructions. The set of instructions, when executed by the processor, cause the processor to acquire training data, the training data comprising: data, an annotation for the data as determined by a user and auxiliary data, the auxiliary data describing at least one location of interest in the data, as considered by the user when determining the annotation for the data. The set of instructions when executed by the processor, further cause the processor to train the model using the training data, by minimising an auxiliary loss function that compares the at least one location of interest to an output of one or more layers of the model and minimising a main loss function that compares the annotation for the data as determined by the user to an annotation produced by the model.

### CROSS-REFERENCE TO RELATED APPLICATION

This present application claims priority to and the benefit of U.S. Provisional Application No. 62/588,575, filed Nov. 20, 2017, which is hereby incorporated by reference in its entirety.

### TECHNICAL FIELD

Various embodiments described herein relate to the field of machine learning. More particularly, but not exclusively, various embodiments relate to systems and methods of training a neural network model.

### BACKGROUND

The general background is in machine learning and neural network models. Machine learning models can be used for many tasks, including annotating (e.g. classifying or producing a label for) large amounts of data in an automated fashion. Machine learning can be particularly useful when annotating images, such as medical images which could otherwise only be classified by highly skilled medical staff.

One class of machine learning models are artificial neural networks (or neural networks). Large amounts of annotated data is typically needed to train a neural network model (e.g. training data). However, annotating data, for example, annotating images by pointing out the presence or location of objects in each image, is time consuming and may be boring for the annotator, potentially leading to loss of accuracy of the annotations. If skilled medical professionals are required to perform each annotation, then the annotation process can also become costly. Therefore, it is desirable to find ways to reduce the amount of annotation data required to train a machine learning model and to make the learning process more efficient, whilst ensuring the quality of the training and the resulting model is maintained.

There is therefore a need for methods and systems that improve upon the above-mentioned problems.

### SUMMARY

According to a first aspect, there is a system for training a neural network model. The system comprises a memory comprising instruction data representing a set of instructions and a processor configured to communicate with the memory and to execute the set of instructions. The set of instructions, when executed by the processor, cause the processor to acquire training data, the training data comprising: data, an annotation for the data as determined by a user, and auxiliary data. The auxiliary data describes at least one location of interest in the data, as considered by the user when determining the annotation for the data. The set of instructions, when executed by the processor then cause the system to train the model using the training data. Causing the processor to train the model comprises causing the processor to: minimise an auxiliary loss function that compares the at least one location of interest to an output of one or more layers of the model, and minimise a main loss function that compares the annotation for the data as determined by the user to an annotation produced by the model.

Using auxiliary data that describes one or more locations of interest in the data, as considered by the user when determining the annotation for the data, means that additional data collected from the user as the user annotates the data (e.g. such as eye-gaze data, gesture data and/or speech data) can be used to speed up the training process, without any additional effort on behalf of the user (the auxiliary data is effectively obtained “for free”). Instead of merely providing the model with the final annotation to learn from, the model is also provided with a plurality of locations in the data that the user considered when making the annotation, which act as a guide to the positions in the data the model should consider when annotating the data. By minimising a loss function that compares the at least one location of interest to an output of one or more layers of the model, the weights of the model are tuned to bring out (e.g. give more significance to) the regions of interest, considered by the user as the user annotated the data. By incorporating this additional data into the training process, the model can be trained more quickly. Furthermore, fewer annotations are required from the user because more data (e.g. eye-gaze, speech and/or gesture data) is extracted from the user during each annotation.

In some embodiments, the auxiliary data comprises eye gaze data and the at least one location of interest comprises at least one location in the data observed by the user when determining the annotation for the data.

In some embodiments, the eye gaze data comprises one or more of: information indicative of which portions of the data the user looked at when determining the annotation for the data, information indicative of the amount of time the user spent looking at each portion of the data when determining the annotation for the data and information indicative of the order in which the user looked at different portions of the data when determining the annotation for the data.

In some embodiments, causing the processor to minimise the auxiliary loss function comprises causing the processor to update weights of the model so as to give increased significance to the at least one location of interest in the data, compared to locations in the data that are not locations of interest.

In some embodiments, causing the processor to minimise the auxiliary loss function comprises causing the processor to update weights of the model so as to give increased significance to locations of interest considered by the user for longer periods of time compared to locations of interest that are considered by the user for shorter periods of time.

In some embodiments, causing the processor to minimise the auxiliary loss function comprises causing the processor to update weights of the model so as to give increased significance to locations of interest in the data that are at least one of: considered during an initial time interval by the user when determining the annotation for the data; considered during a final time interval by the user when determining the annotation for the data; and considered a plurality of times by the user when determining the annotation for the data.

In some embodiments, the auxiliary data comprises an image, image components of the image corresponding to a portion of the data.

In some embodiments, the image comprises a heat map. Values of image components in the heat map are correlated with whether each image component corresponds to a location of interest in the data and/or a duration that the user spent considering each corresponding location of the data when determining the annotation for the data.

In some embodiments, causing the processor to minimise an auxiliary loss function comprises causing the processor to compare the image data to an output of one or more convolutional layers of the model.

In some embodiments, causing the processor to minimise an auxiliary loss function comprises causing the processor to compare the auxiliary data to an output of one or more dense layers of the model.

In some embodiments, causing the processor to train the model comprises causing the processor to minimise one or more of: the auxiliary loss function and the main loss function in parallel; the auxiliary loss function before minimising the main loss function; and the auxiliary loss function to within a predetermined threshold, after which the model is further trained using the main loss function.

In some embodiments, the set of instructions, when executed by the processor, further cause the processor to: calculate a combined loss function, the combined loss function comprising a weighted combination of the main loss function and the auxiliary loss function; and adjust one or more weights associated with the weighted combination of the combined loss function, so as to change the emphasis of the training between minimising the main loss function and minimising the auxiliary loss function.

In some embodiments, the model comprises a modified U-Net architecture.

According to a second aspect, there is a method of training a neural network model. The method comprises acquiring training data. The training data comprises: data, an annotation for the data as determined by a user and auxiliary data, the auxiliary data describing at least one location of interest in the data, as considered by the user when determining the annotation for the data. The method further comprises training the model using the training data. The training comprises: minimising an auxiliary loss function that compares the at least one location of interest to an output of one or more layers of the model; and minimising a main loss function that compares the annotation for the data as determined by the user to an annotation produced by the model.

According to a third aspect, there is a computer program product comprising a non-transitory computer readable medium, the computer readable medium having computer readable code embodied therein, the computer readable code being configured such that, on execution by a suitable computer or processor, the computer or processor is caused to perform the method of any of the embodiments described herein.

### BRIEF DESCRIPTION OF THE DRAWINGS

For a better understanding of the embodiments, and to show more clearly how they may be carried into effect, reference will now be made, by way of example only, to the accompanying drawings, in which:

FIG. 1 illustrates an example system according to an embodiment;

FIG. 2 illustrates example auxiliary data comprising eye-gaze data presented in graphical form, according to an embodiment;

FIG. 3 illustrates example auxiliary data comprising eye-gaze data presented in the form of an image according to an embodiment;

FIG. 4 illustrates example auxiliary data presented in the form of a heat map according to an embodiment;

FIGS. 5a and 5b illustrates an example process according to an embodiment; and

FIG. 6 illustrates a computer-implemented method according to an embodiment.

### DETAILED DESCRIPTION OF EMBODIMENTS

As noted above, there is provided an improved method and system for training a neural network model, which overcomes some of the existing problems.

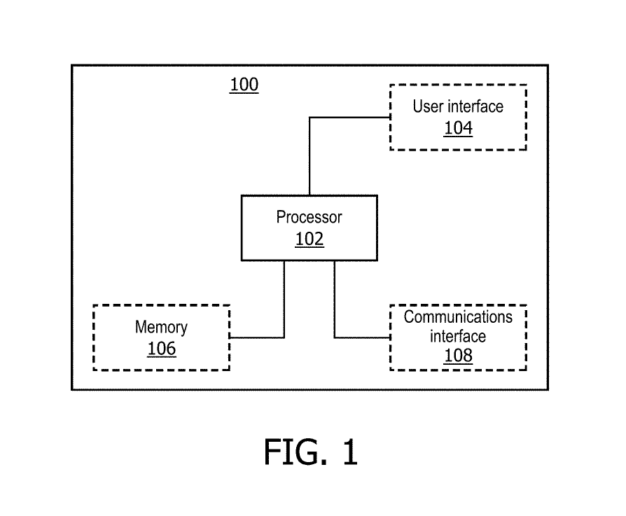

FIG. 1 shows a block diagram of a system 100 according to an embodiment that can be used for training a neural network model. With reference to FIG. 1, the system 100 comprises a processor 102 that controls the operation of the system 100 and that can implement the method described herein.

The system 100 further comprises a memory 106 comprising instruction data representing a set of instructions. The memory 106 may be configured to store the instruction data in the form of program code that can be executed by the processor 102 to perform the method described herein. In some implementations, the instruction data can comprise a plurality of software and/or hardware modules that are each configured to perform, or are for performing, individual or multiple steps of the method described herein. In some embodiments, the memory 106 may be part of a device that also comprises one or more other components of the system 100 (for example, the processor 102 and/or one or more other components of the system 100). In alternative embodiments, the memory 106 may be part of a separate device to the other components of the system 100.

In some embodiments, the memory 106 may comprise a plurality of sub-memories, each sub-memory being capable of storing a piece of instruction data. In some embodiments where the memory 106 comprises a plurality of sub-memories, instruction data representing the set of instructions may be stored at a single sub-memory. In other embodiments where the memory 106 comprises a plurality of sub-memories, instruction data representing the set of instructions may be stored at multiple sub-memories. For example, at least one sub-memory may store instruction data representing at least one instruction of the set of instructions, while at least one other sub-memory may store instruction data representing at least one other instruction of the set of instructions. Thus, according to some embodiments, the instruction data representing different instructions may be stored at one or more different locations in the system 100. In some embodiments, the memory 106 may be used to store information, data, signals and measurements acquired or made by the processor 102 of the system 100 or from any other components of the system 100.

The processor 102 of the system 100 can be configured to communicate with the memory 106 to execute the set of instructions. The set of instructions, when executed by the processor 102 may cause the processor 102 to perform the method described herein. The processor 102 can comprise one or more processors, processing units, multi-core processors and/or modules that are configured or programmed to control the system 100 in the manner described herein. In some implementations, for example, the processor 102 may comprise a plurality of (for example, interoperated) processors, processing units, multi-core processors and/or modules configured for distributed processing. It will be appreciated by a person skilled in the art that such processors, processing units, multi-core processors and/or modules may be located in different locations and may perform different steps and/or different parts of a single step of the method described herein.

Returning again to FIG. 1, in some embodiments, the system 100 may comprise at least one user interface 104. In some embodiments, the user interface 104 may be part of a device that also comprises one or more other components of the system 100 (for example, the processor 102, the memory 106 and/or one or more other components of the system 100). In alternative embodiments, the user interface 104 may be part of a separate device to the other components of the system 100.

A user interface 104 may be for use in providing a user of the system 100 (for example, a researcher, a designer or developer of neural network models, a healthcare professional, a subject, or any other user of a neural network model) with information resulting from the method according to embodiments herein. The set of instructions, when executed by the processor 102 may cause processor 102 to control one or more user interfaces 104 to provide information resulting from the method according to embodiments herein. Alternatively or in addition, a user interface 104 may be configured to receive a user input. In other words, a user interface 104 may allow a user of the system 100 to manually enter instructions, data, or information. The set of instructions, when executed by the processor 102 may cause processor 102 to acquire the user input from one or more user interfaces 104.

A user interface 104 may be any user interface that enables rendering (or output or display) of information, data or signals to a user of the system 100. Alternatively or in addition, a user interface 104 may be any user interface that enables a user of the system 100 to provide a user input, interact with and/or control the system 100. For example, the user interface 104 may comprise one or more switches, one or more buttons, a keypad, a keyboard, a mouse, a mouse wheel, a touch screen or an application (for example, on a tablet or smartphone), a display screen, a graphical user interface (GUI) or other visual rendering component, one or more speakers, one or more microphones or any other audio component, one or more lights, a component for providing tactile feedback (e.g. a vibration function), or any other user interface, or combination of user interfaces.

In some embodiments, as illustrated in FIG. 1, the system 100 may also comprise a communications interface (or circuitry) 108 for enabling the system 100 to communicate with interfaces, memories and/or devices that are part of the system 100. The communications interface 108 may communicate with any interfaces, memories and devices wirelessly or via a wired connection.

It will be appreciated that FIG. 1 only shows the components required to illustrate this aspect of the disclosure and, in a practical implementation, the system 100 may comprise additional components to those shown. For example, the system 100 may comprise a battery or other power supply for powering the system 100 or means for connecting the system 100 to a mains power supply.

In more detail, as noted above, the memory 106 comprises instruction data representing a set of instructions. Briefly, the set of instructions, when executed by the processor 102 of the system 100 cause the processor 102 to acquire training data. The training data comprises data, an annotation for the data as determined by a user and auxiliary data, the auxiliary data describing at least one location of interest in the data, as considered by the user when determining the annotation for the data. The set of instructions, when executed by the processor 102 of the system 100 further cause the processor 102 to train the model using the training data. Causing the processor 102 to train the model comprises causing the processor to: minimise an auxiliary loss function that compares the at least one location of interest to an output of one or more layers of the model, and minimise a main loss function that compares the annotation for the data as determined by the user to an annotation produced by the model.

As noted briefly above, the system herein is based on the realisation that auxiliary (e.g. additional) data can be obtained from the user as the user annotates the data, that indicates which parts of the data the user considered (e.g. looked at) when determining (e.g. working out) the correct annotation. Such parts of the data are referred to herein as locations of interest and this knowledge of locations of interest in the data can be used to train a neural network model to give more weight to the locations of interest in the data when producing an annotation. In this way, the locations of interest provide additional data that can be used to train the model. This helps to train the model more quickly and efficiently. Furthermore, the locations of interest can be obtained “for free” (e.g. without the user having to provide any additional annotations) from, for example, eye-gaze, gesture or speech data obtained as the user annotates the training data. In this way, the training is made more efficient and cost effective for users.

Artificial neural networks or, simply, neural networks, will be familiar to those skilled in the art, but in brief, a neural network is a type of model that can be used to annotate (for example, classify or label) data (for example, classify or produce a label or annotation for image data). The structure of a neural network is inspired by the human brain. Neural networks are comprised of layers, each layer comprising a plurality of neurons. Each neuron comprises a mathematical operation. In the process of classifying data, the mathematical operation of each neuron is performed on the data to produce a numerical output, and the outputs of each layer in the neural network are fed into the next layer sequentially. The magnitude of the numerical output of a neuron (when classifying data) is often referred to as the “activation level” of that neuron. In some neural networks, such as convolutional neural networks, lower layers in the neural network (i.e. layers towards the beginning of the series of layers in the neural network) are activated by (i.e. their output depends on) small features or patterns in the data being classified, while higher layers (i.e. layers towards the end of the series of layers in the neural network) are activated by increasingly larger features in the data being classified. As an example, where the data comprises an image and the model comprises a neural network, lower layers in the neural network are activated by small features (e.g. such as edge patterns in the image), mid-level layers are activated by features in the image, such as, for example, larger shapes and forms, whilst the layers closest to the output (e.g. the upper layers) are activated by entire objects in the image. Data of different classifications create different activation patterns (e.g. have different activation signatures in the network). For example, images of hearts produce different activation patterns to images of lungs. A neural network thus classifies data according to the activation pattern produced in the neural network.

In some examples herein, where the data comprises an image and the model is for classifying the contents of the image, each neuron in the neural network may comprise a mathematical operation comprising a weighted linear sum of the pixel (or in three dimensions, voxel) values in the image followed by a non-linear transformation. Examples of non-linear transformations used in neural networks include sigmoid functions, the hyperbolic tangent function and the rectified linear function. The neurons in each layer of the neural network generally comprise a different weighted combination of a single type of transformation (e.g. the same type of transformation, sigmoid etc. but with different weightings). As will be familiar to the skilled person, in some layers, the same weights may be applied by each neuron in the linear sum; this applies, for example, in the case of a convolutional layer. The output of each neuron may be a number and as noted above, the magnitudes of the numerical outputs of the neurons form a neuron activation pattern that may be used to classify the image.

Generally, the neural network model (referred to herein as “the model”) may comprise any type of neural network model that can be used to annotate (e.g. classify) data. Examples of models include, but are not limited to feed forward models (such as convolutional neural networks, autoencoder neural network models, probabilistic neural network models and time delay neural network models), radial basis function network models, recurrent neural network models (such as fully recurrent models, Hopfield models, or Boltzmann machine models), or any other type of neural network model. The skilled person will be aware of other types of models that the teachings herein will apply to.

In some embodiments, the model has a modified U-Net architecture. The U-Net architecture is well suited to applications involving, for example, image data because the layers of a U-Net model are all convolution layers. It further requires less input data compared to other types of neural network architectures. It is therefore well suited for adaption to processing locations of interest represented in the form of a heatmap (or other image data). The skilled person will appreciate however that other architectures are also possible.

In general, the neural network model may be used to classify (e.g. provide annotations or labels for) data. The data may be any type of data that can be visibly displayed to a user as the user annotates the data. For example, the data may comprise images (e.g. image data), videos (e.g. video data), data comprising text such as documents or records, data comprising a waveform that can be represented visually (e.g. an electrocardiogram (ECG) or similar) or any other type of data that can be visibly displayed to a user as the user annotates the data. In some embodiments, the data comprises medical data, such as medical images (e.g. x-ray images, ultrasound images, etc.) or medical records. Generally, the data may comprise two dimensional data or three dimensional data (for example, three dimensional images or video). In some embodiments, the data may comprise viewable data that can be displayed to a user. In some embodiments, the data may be arranged in a definite (e.g. fixed or reproducible) arrangement, for example, the arrangement may be deducible (e.g. viewable or derivable) by both a human annotator and the model. For example, the data may comprise an image, the pixels (or voxels in 3D) of the image being arranged in a fixed arrangement. In another example, the data may comprise a text document that can be rendered in the same way to both a human and the model. It will be appreciated that these are only examples of the types of data that may be processed by a neural network model and that the skilled person will be familiar with other types of viewable data that may be classified by a neural network model.

The neural network model may be trained to take in data and produce an annotation for the data, such as a classification or label for the data. For example, the annotation may describe the contents of the data. In some embodiments, the model comprises an object detection model whereby the model detects whether a particular object or feature is present in the data or not. In some embodiments, the object comprises a stent in a medical image. In some embodiments, the model comprises a localication model whereby the model indicates a location in the data corresponding to a particular object or feature of the data. In some embodiments, the model may determine the location of a stent in a medical image. In examples where the data is image data, such as medical image data, the annotation may describe the contents of the image, or in the case of medical imaging, the annotation may describe one or more anatomical features or objects in the image. In some examples, the annotation may indicate a diagnosis of a medical condition that is observable from the medical image. In examples where the data is a document, such as a medical record, the model may be trained to annotate the data by determining certain features or making certain deductions from the contents of the document (for example, based on a medical record, the model may be trained to determine that a patient may be at a high risk of developing diabetes). In embodiments where the data comprises a waveform, the model may be trained, for example, to determine the locations of features such as anomalies in the waveform. It will be appreciated that these are merely examples of the types of ways that data may be annotated however, and that the skilled person will be able to think of other annotations that may be produced by a model.

As noted above, the set of instructions, when executed by the processor 102 cause the processor 102 to acquire training data, the training data comprising: data, an annotation for the data as determined by a user and auxiliary data, the auxiliary data describing at least one location of interest in the data, as considered by the user when determining the annotation for the data.

Generally, the training data comprises example portions of data that are illustrative of the type of data that the model is to classify, as described above. For example, if the model is for classifying image data (such as medical image data) then the training data comprises examples of the same types of images that the model is to classify. The annotation for the data is determined by a user and comprises an example of the same type of annotation (e.g. classification or label) that the model is to produce, as described above.

The training data also comprises auxiliary data that describes at least one location of interest in the data, as considered by the user when determining the annotation for the data. In some embodiments the auxiliary data comprises eye-gaze data and the at least one location of interest in the data comprises at least one location in the data that the user observed (e.g. looked at) when determining the annotation for the data. Generally, locations in the data that are looked at by the user as the user determines the annotation may represent features of the data that are important to determine the correct annotation for the data. By providing this information to the model therefore, the model may be guided during the training process to consider these (or equivalent) locations in other data when annotating the other data.

In some embodiments, the eye gaze data comprises one or more of: information indicative of which portions of the data the user looked at when determining the annotation for the data; information indicative of the amount of time the user spent looking at each portion of the data when determining the annotation for the data; and information indicative of the order in which the user looked at different portions of the data when determining the annotation for the data. In this way, the relative importance of different portions of the data can be assessed. For example, a location of interest in the data may be particularly important (e.g. a determining factor) in producing the correct annotation (or classification) if the user considered the location of interest for a long time compared to other locations in the data, or if the user came back to the location of interest many times (indicating that the location of interest may be one of the most important parts of the data) when determining the appropriate annotation for the data. Furthermore, the order in which the user considers each location of interest may also be important. For example, the user may initially be drawn to the features in the data that are most important to consider when determining the correct annotation for the data. Alternatively, it may be that features that the user looks at last that are the more important features, for example, if it takes time for the user to “hone in” on finer features of the data that are used to determine the final annotation.

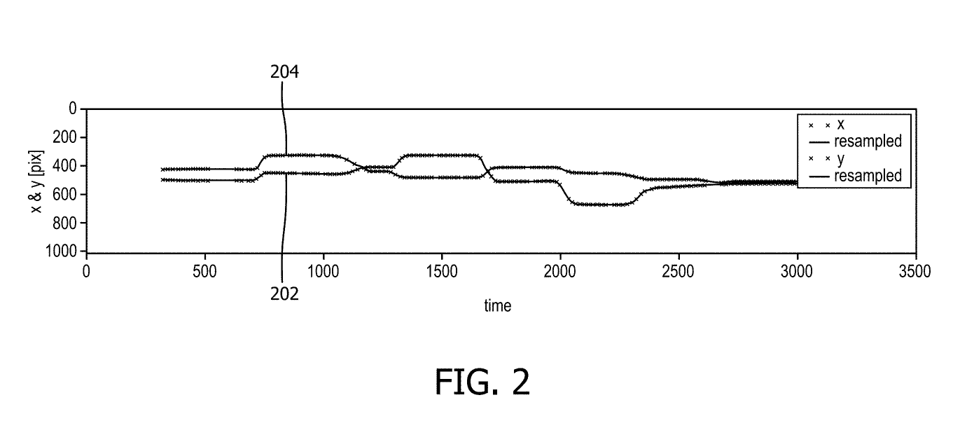

FIG. 2 shows an example of auxiliary data according to an embodiment. In this embodiment, data comprises an image and the auxiliary data comprises a graph. The x-axis of the graph represents time, and the y axis represents co-ordinates of the image. The line 202 indicates the x axis coordinate of the image that the user considered at each point in time and the line 204 indicates they axis coordinate of the image that the user considered at each point in time as the user determined the annotation for the image. From this graph, it can be seen, for example, that the first location of interest observed by the user around the time “500” was the coordinate (x,y)=(500, 400).

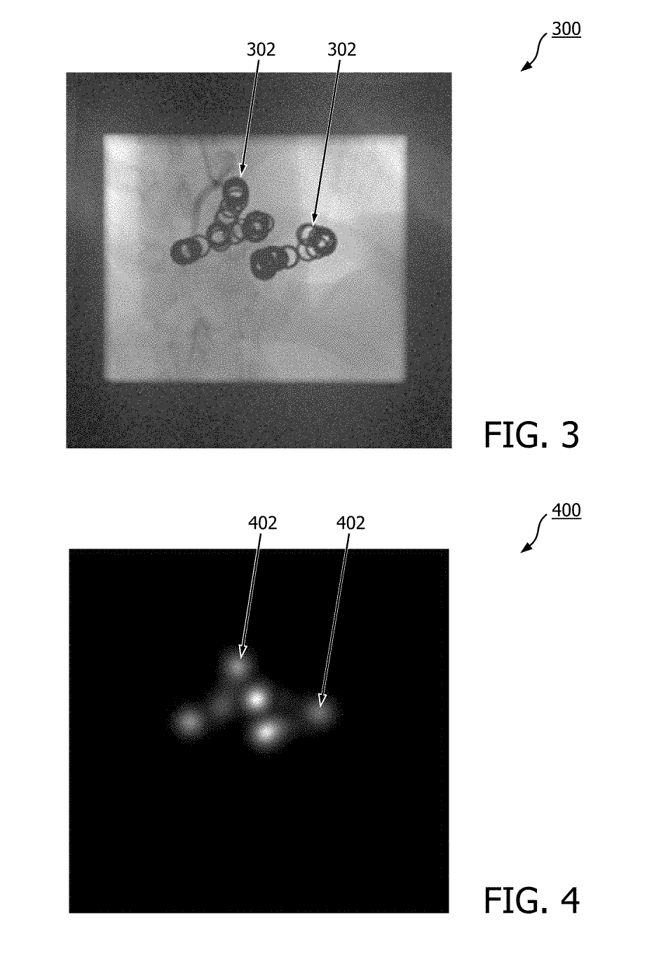

In some embodiments, the auxiliary data comprises an image having image components (e.g. pixels, or in three dimensions, voxels), each image component corresponding to a portion of the data. FIG. 3 shows an example of auxiliary data in an embodiment whereby the data comprises an image. In this embodiment, the auxiliary data 300 as shown in FIG. 3 comprises a copy of the image overlain with markers 302 indicating the at least one location of interest in the image.

In some embodiments, the auxiliary data comprises a heat map, wherein values of image components (e.g. pixels or voxels) in the heat map are correlated with whether each image component corresponds to a location of interest in the data and/or a duration that the user spent considering the corresponding location of the data when determining the annotation for the data. For example, the value of each image component may be proportional to the length of time that the user spent considering (e.g. looking at or gesturing at) the corresponding portion of the data whilst determining the annotation for the data. FIG. 4 shows an example embodiment whereby the auxiliary data is a heat map 400. In this embodiment, the value of each image component is proportional to the length of time that the user spent observing (e.g. looking at) the corresponding portion of the data. For example, the whiter (e.g. hotter) an image component is, the longer the user spent observing the corresponding portion of the data when determining the annotation. In FIG. 4, the white areas 402, coincide with the locations of interest in the data. The skilled person will appreciate that heat maps may be correlated with longevity of gaze in other ways to those described herein, which are merely provided as examples. For example, the values of the heat map may not necessarily be directly proportional to the length of time the user spent observing the corresponding portion of the data. For example, the values may be inversely proportional (e.g. “colder” values corresponding to the regions that were observed the longest) and/or scaled according to a logarithmic or square of the observation time.

In some embodiments, a heat map may be produced by convolving discreet gaze or gesture coordinates with a density kernel, such as a Gaussian density kernel. This effectively spreads the co-ordinates of individual locations (e.g. points) of interest out into regions of interest.

Although various examples of gaze data have been provided, it will be appreciated that other formats of gaze-data are also possible, such as a human-engineered feature representations, PCA-based representation, or an encoding of the locations of interest (e.g. eye- gaze/gesture/speech co-ordinates) into a continuous-valued summary vector (for example, using an LSTM recurrent neural network as it is commonly done in natural language processing), compressed representations, random projections, or sparse representations as coordinate value tuples.

In some embodiments the auxiliary data comprises gesture data and the at least one location of interest comprises at least one location that the user gesticulated at (e.g. pointed at, nodded at, or moved their head towards) whilst determining the annotation for the data.

In some embodiments, the auxiliary data comprises speech data and the at least one location comprises at least one location that the user commented on (e.g. make an aural reference to) in the speech data. For example the user may provide speech cues whilst working out the appropriate annotation for the data (for example, the user may refer to the contents of the “left hand upper corner of the image”).

Generally speaking therefore, locations of interest may comprise locations in the data (or portions of the data) that the user used to determine the correct annotation for the data. It will be appreciated that the at least one location of interest in the data may be derived from any combination of the examples above (for example, one or more locations of interest derived from eye-gaze data, in addition, or alternatively to one or more locations of interest derived from speech data, in addition, or alternatively to one or more locations of interest derived from gesture data).

In some embodiments, the processor 102 may be caused to acquire the training data from a database (for example, the training data may comprise historic data collected at an earlier time). Such a database may be stored locally to system 100. Alternatively, such a database may be stored remotely to system 100, for example on an external server.

In some embodiments, the processor 102 may be caused to acquire the training data dynamically (e.g. in real time) from a user. For example, the processor 102 may be configured to interact with one or more pieces of equipment, such as medical equipment, in order to acquire data for the training data. For example, the processor 102 may be caused to interface with the medical equipment and send instructions to the medical equipment to instruct the medical equipment to acquire one or more medical images for use in the training data. The set of instructions when executed by the processor 102, may further cause the processor 102 to provide instructions to a user interface 104 to render the data to a user of the system for the user to view. The user may then be able to determine the annotation for the data, from the rendered data.

In some embodiments, system 100 may further comprise a user interface 104 or user interfaces 104 suitable for capturing visual images and/or audio data from a user as the user annotates the data. For example, where the auxiliary data comprises eye gaze data and/or gesture data, system 100 may further comprise a recording device (e.g. an image capture device, camera or video recorder) suitable for recording eye-gaze movements of the user (e.g. the movements and/or direction of movements of the user's eye(s)) and/or gestural movements of the user (e.g. movements of the user's limbs, hands, head or other body parts). In some embodiments, the set of instructions, when executed by the processor 102, may further cause the processor 102 to determine, from video or image data of a user, the at least one location of interest in the data. In some embodiments, said video or image data may comprise video or image data of the user as the user annotates the data (e.g. as the user is in the process of annotating the data). The skilled person will be familiar with methods of determining locations of a user's gaze on a screen from images of a user's eyes and/or with methods for converting gesture data (such as pointing) into an equivalent location on a screen.

In some embodiments, system 100 may comprise a user interface 104 for recording audio, such as a microphone or other audio recording device. In some embodiments, the set of instructions, when executed by the processor 102, may further cause the processor 102 to determine, from an audio recording of a user, the at least one location of interest in the data. In some embodiments, the audio recording may be made as the user annotates the data. In some embodiments, the set of instructions, when executed by the processor 102, may further cause the processor 102 to determine the at least one location of interest in the data from the audio recording using language processing techniques. For example, the processor 102 may be caused to isolate keyword terms in the speech (e.g. words such as “top”, “bottom” or “side”) and match these to locations in (or portions of) the data.

It will also be appreciated that the system may further be used on three-dimensional data, for example, locations of interest may be determined in three dimensional data through eye movements, gestures and speech combined with information describing the orientation or portion of the three dimensional data that is displayed to the user during the eye movements, gestures or production of the speech. In some embodiments, the system may comprise user interfaces 104 such as displays and recording devices suitable for displaying data and capturing eye-gaze/gestures and/or speech in an augmented reality environment, thus providing increased options for annotating and capturing auxiliary data in three dimensions.

Although examples have been provided herein of ways in which a processor 102 may be caused to determine locations of interest in data from video recordings, audio recordings and images of a user, it will be appreciated these are merely examples and that other methods are also possible.

After the training data is acquired, the set of instructions, when executed by the processor 102, cause the processor 102 to train the model using the training data. The processor 102 is caused to train the model by minimising an auxiliary loss function that compares the at least one location of interest to an output of one or more layers of the model, and minimising a main loss function that compares the annotation for the data as determined by the user to an annotation produced by the model.

The skilled person will be familiar with main loss functions (or cost functions) whereby an annotation for the data as determined by the user is compared to an annotation produced by the model. The type of loss function that the main loss function comprises will depend on the type of annotation produced by the model. For example, for models where the range of possible values of the annotation is continuous (e.g. a location model whereby the model outputs x-y coordinates), the main loss function may comprise a mean square error (MSE) loss function. In classification problems whereby the output is discreet (e.g. the annotation indicates whether an object or feature is present in the data or not present in the data), the main loss function may comprise a cross entropy loss function. It will be appreciated however that these are merely examples and that the skilled person will be familiar with other forms of loss function that could be used for the main loss function.

In some embodiments, causing the processor 102 to minimise an auxiliary loss function comprises causing the processor 102 to compare the auxiliary data to an output of one or more convolutional layers of the model. This may be appropriate, for example, if the auxiliary data comprises an image as the output values of neurons in a convolutional layer of a model, when taken in combination, effectively represent an image (e.g. a convolution of an input image). In this way, for example, a heat map can be compared to an output of one of the convolutional layers to determine whether the convolutional layer produces an image corresponding to (e.g. highlighting, or bringing out) the locations of interest, or features located at the locations of interest in the auxiliary data.

In some embodiments, causing the processor 102 to minimise an auxiliary loss function comprises causing the processor 102 to compare the auxiliary data to an output of one or more dense layers of the model. The neurons in dense layers of neural network models generally produce numerical values that can be more easily compared to auxiliary data represented as values.

It will be appreciated however that the auxiliary data may not be directly compared to the output of a layer of a model. For example, in some embodiments, one or both of the output of a layer and the auxiliary data may be converted into a form suitable for making the comparison.

In embodiments where the auxiliary data comprises continuous values (e.g. as opposed to digital values), such as where the auxiliary data comprises an image such as a heat map, the auxiliary loss function may comprise a mean-squared error loss function. This is merely an example however, and the skilled person will be familiar with other types of loss function suitable for use with continuous value auxiliary data. For example, in embodiments where the auxiliary data comprises an image, the set of instructions, when executed by the processor 102, may cause the processor 102 to normalise the auxiliary data image so that it forms a probability distribution (e.g. so that the image integrates to unity). In this case the auxiliary loss function may comprise a (categorical) cross-entropy loss function or a kullback-leibner divergence loss function.

By minimising an auxiliary loss function that compares the at least one location of interest to an output of one or more layers of the model, specific layers of the model can be trained to “bring out” or give added emphasis to the locations of interest (e.g. the locations that the user considered when determining an annotation) in the data when classifying the data.

Generally, when a machine learning model is created (e.g. initialised), weights in the model are set to arbitrary values. In effect, this means that the model initially treats every part of the data equally when making an annotation. In embodiments herein, the auxiliary data is compared to one or more hidden layers of the model. The output(s) of each layer of a model generally correspond to features or portions of the data that the model uses to produce an annotation. Therefore, by comparing the output of one or more such layers to auxiliary data comprising locations of interest in the data, it can be determined whether the model is considering the most pertinent parts or features of the data when making a classification. Thus, by minimising the auxiliary loss function, a particular layer can be trained to output the at least one location of interest in the auxiliary data, thereby training the model to give most weight to the most important features of the data. In this way, the weights are updated so as to quickly tune the model (e.g. from the arbitrary values of the weights as set when the model was created) to place added emphasis on certain areas of the data over others when making an annotation. This moves the weights of the model towards convergence more quickly than by merely minimising a main loss function that compares the annotation produced by the model (e.g. the output of the model) to the annotation determined by the user. Furthermore, the auxiliary data can be obtained without any additional effort on the part of the user, because the auxiliary data can be obtained by observing the user as they determine the annotation. This therefore saves time and effort for the user (potentially resulting in cost savings if the user/annotator is highly skilled) whilst maintaining the quality of annotations of the resulting trained model.

In some embodiments, causing the processor 102 to minimise the auxiliary loss function may comprise causing the processor 102 to update weights of the model so as to give increased significance to the at least one location of interest in the data, compared to locations in the data that are not locations of interest. In this way, the model places increased significance on the same locations in the data as the locations of interest that the user considered when the user determined the annotation for the data.

In some embodiments, causing the processor 102 to minimise the auxiliary loss function comprises causing the processor 102 to update weights of the model so as to give increased significance to locations of interest considered by the user for longer periods of time compared to locations of interest that are considered by the user for shorter periods of time. In this way, the model places increased significance on locations in the data that the user spends most time observing when determining an annotation for the data (as these may be the most relevant, discriminating or subtle portions of the data).

In some embodiments, causing the processor 102 to minimise the auxiliary loss function comprises causing the processor 102 to update weights of the model so as to give increased significance to locations of interest in the data that are considered by the user during an initial time interval when determining the annotation for the data. For example, increased significance may be given to locations of interest in the data (e.g. parts of the data) that the user considered (e.g. observed, looked at, gesticulated towards or spoke about) first, or during the first half, or a first quarter (or any other proportion) of the time interval that the user spent determining the annotation for the data. Such features, that the user considered first may comprise the largest, most significant features when making the determination.

In some embodiments, causing the processor 102 to minimise the auxiliary loss function comprises causing the processor 102 to update weights of the model so as to give increased significance to locations of interest in the data (e.g. parts of the data) that the user considered during a final time interval by the user when determining the annotation for the data. For example, increased significance may be given to parts of the data that the user considered (e.g. observed, looked at, gesticulated towards or spoke about) last, or during a second half, or a last quarter (or any other proportion) of the time interval that the user spent determining the annotation for the data. Such features that the user considered last may comprise the most subtle or discriminating features that the user didn't initially notice, which ultimately may have the most impact on the annotation.

In some embodiments, causing the processor 102 to minimise the auxiliary loss function comprises causing the processor 102 to update weights of the model so as to give increased significance to locations of interest in the data (e.g. parts of the data) that the user considered a plurality of times when determining the annotation for the data. For example, the model may give increased significance to parts of the data that the user kept coming back to, as these may comprise the most significant or important features to make the classification, or they may indicate an anomaly that may be significant to the classification.

It will be appreciated that different combinations are also possible, for example, increased significance may be given to any individual one of, any combination or permutation of ones of: locations of interest in the data considered in an initial time interval, a final time interval and/or locations of interest that the user considered a plurality of times when determining the annotation for the data.

As noted above, the main loss function and the auxiliary loss function serve different purposes and therefore depending on the stage of the training and/or the training goals, it may be beneficial to focus on minimising one or the other of the loss functions at different times. In some embodiments, causing the processor 102 to train the model comprises causing the processor 102 to minimise the auxiliary loss function and the main loss function in parallel (e.g. both the main loss function and the auxiliary loss function may be updated every time training data is processed by the model). In this way, the hidden layers of the model are trained concurrently with the output layers. In some embodiments, causing the processor 102 to train the model comprises causing the processor 102 to minimise the auxiliary loss function before minimising the main loss function. For example, it may be computationally more efficient to train the hidden layers to focus on the locations of interest in the data, before training the upper and/or output layer(s) to produce the correct annotation. In some embodiments, causing the processor 102 to train the model comprises causing the processor 102 to minimise the auxiliary loss function to within a predetermined threshold, after which the model is further trained using the main loss function. In this way, the lower layers of the model may be partially trained using the auxiliary data and refined on the specific problem that the model is to address. It will be appreciated that various combinations of training regimes are also possible, for example, the training may comprise firstly minimising the auxiliary loss function to within a threshold, secondly minimising the auxiliary loss function and main loss function in parallel followed by a period of minimising just the main loss function. It will also be apparent that the various stages may be repeated, or combined in any order. For example, after a period of just minimising the main loss function, the processor 102 may be caused to minimise the auxiliary loss function, for example, if new training data is acquired.

In some embodiments, the set of instructions, when executed by the processor 102, further cause the processor 102 to calculate a combined loss function, the combined loss function comprising a weighted combination of the main loss function and the auxiliary loss function, and adjust one or more weights associated with the weighted combination of the combined loss function, so as to change the emphasis of the training between minimising the main loss function and minimising the auxiliary loss function. For example, the combined loss function may comprise a weighted linear combination of the main loss function and the auxiliary loss function. The weights associated with the weighted combination may be adjusted to change the emphasis of the training, for example, by reducing the weight of the auxiliary loss function compared to the weight of the main loss function in order to place more emphasis on the results of minimising the main loss function in the training process, or vice versa. In some embodiments, the loss weights can be optimized using cross-validation or selected based on prior knowledge. In some embodiments, the weights of the weighted linear combination may be evolved over time, for example, in some embodiments, the weight associated with the auxiliary loss function in the weighted combination may be decreased (e.g. linearly) over time (for example from 1 to 0 over the course of the training). Alternatively or additionally, the weight associated with the main loss function in the weighted linear combination may be increased (e.g. linearly) over time (for example, from 0 to 1 over the course of the training). In this way, the emphasis of the training may be dynamically changed over time from minimising the auxiliary loss function to minimising the main loss function. In some embodiments, the combined loss function may be used in backpropagation-type learning algorithms.

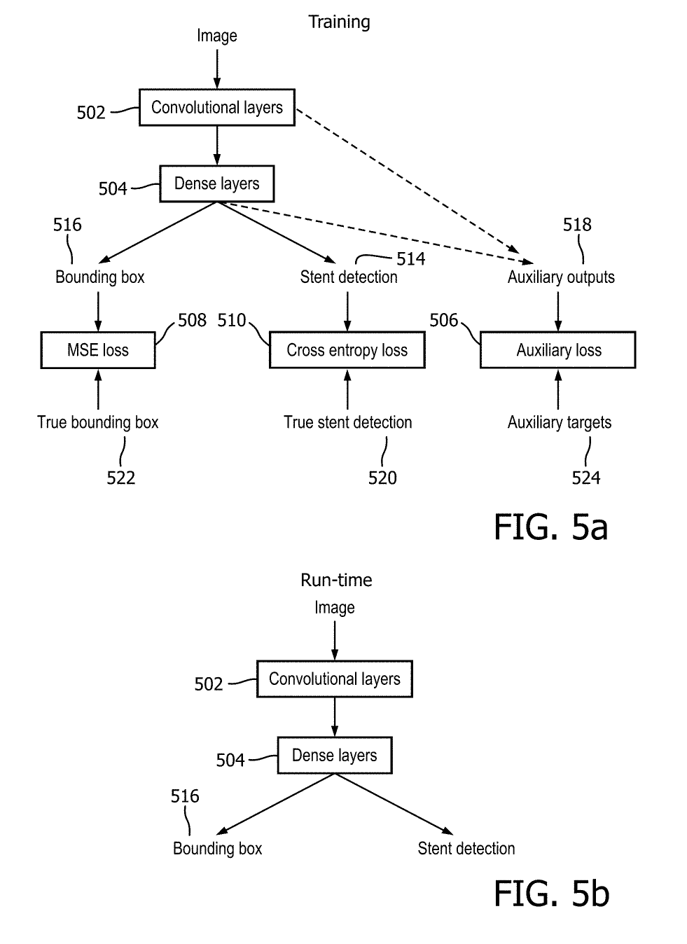

FIG. 5 illustrates an example process that can be performed by the system 100 according to an embodiment. In this embodiment, the model is for the joint tasks of stent detection and stent localisation in a medical image. Stent detection comprises determining whether a stent is present in an image or not, with output annotations, for example, of “stent present” or “stent not present”. Stent localisation comprises determining the location of a stent in a medical image and comprises outputting annotations such as the x,y coordinates of the centre of a bounding box surrounding the stent and the height and width of the stent. It will be appreciated that the teachings herein are more widely applicable to object detection and/or object location models more generally.

In this embodiment therefore, the training data comprises medical images comprising stents. The medical images are annotated by a user. The user provides two annotations, a first annotation describes whether a stent is i) present or ii) not present in the image and the second annotation describes the location of the stent (if a stent is present in the image) in the form of x,y coordinates indicating the centre of a bounding box surrounding the stent and a height and width of said bounding box. The training data further comprises auxiliary data comprising eye gaze data that indicates at least one location of interest in each medical image that the user considered (e.g. looked at) when determining the appropriate annotations for the data. Training data comprising eye gaze data and medical images was described above with respect to system 100 and the details therein will be understood to equally apply here.

In this embodiment, the model comprises a neural network model comprising convolutional layers 502 and dense layers 504. A system, such as the system 100 trains the model using the training data by minimising an auxiliary loss function 506 that compares the at least one location of interest to an output of one or more layers of the model and first and second main loss functions 508, 510, one for the detection problem 508 and one for the localisation problem 510, that compare their respective annotations for the data as determined by the user to annotations produced by the model.

FIG. 5a shows the interactions between different parts of the model (represented by square boxes) and different input and output data during the training process. An image 512 is input and processed by convolutional 502 and dense 504 layers of the model to produce outputs comprising an indication of whether a stent is present 514 and an indication of the location of the stent (if any) 516. The model also produces outputs from each layer of the model (labelled auxiliary outputs 518).

Annotations produced by the user are then fed into the model. As noted above, in this embodiment, the annotations comprise an indication of whether a stent is present in the image 520 and the location of a bounding box 522. Auxiliary data 524 in the form of one or more locations of interest that the user looked at when determining the annotations (e.g. eye gaze data) is also fed into the model.

The model is then trained by minimising an auxiliary loss function 506 that compares the at least one location of interest in the gaze data 524 to an output of one or more layers of the model. Depending on whether the auxiliary data is in the form of an image (e.g. a heat map) or some other form (e.g. graphical or vectoral), the auxiliary data may be compared to the output of one or more convolutional layers 502 or dense layers 504 respectively.

The training further comprises minimising a first main loss function 510 that compares the annotation of whether a stent is present as produced by the model 514 to the annotation of stent presence as determined by the user 520. In this case the first main loss function 510 may comprise a cross entropy loss function or any other loss function suitable for a classification problem.

The training further comprises minimising a second main loss function that compares the annotation of the location of the stent in the image as produced by the model 516 to the annotation of the location as determined by the user 522. In this case the second main loss function 510 may comprise a minimum squared error loss function or any other loss function suitable for a regression problem.

Training a model using main and auxiliary loss functions was described in detail above with respect to system 100 and the details therein will be understood to apply equally to the embodiment in FIG. 5a.

FIG. 5b illustrates the data flow through the final trained model (e.g. at run-time). When trained, the model takes in an image which is processed by the convolutional 502 and/or dense 504 layers of the model to produce the stent detection and localisation (e.g. bounding box) outputs. It should be noted that the auxiliary data is not required as an input into the trained model and is only used in the training process as illustrated in FIG. 5a. In this way, the model is effectively and efficiently trained.

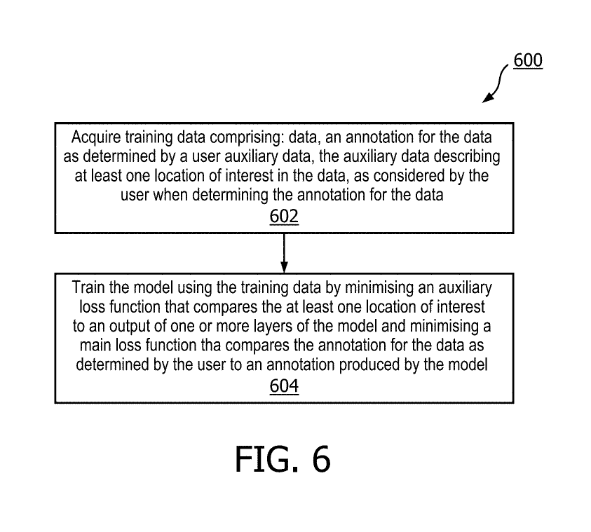

FIG. 6 illustrates a computer-implemented method 600 for training a neural network model according to an embodiment. The illustrated method 600 can generally be performed by or under the control of the processor 102 of the system 100. The method may be partially or fully automated according to some embodiments.

The method comprises acquiring training data, the training data comprising: data, an annotation for the data as determined by a user and auxiliary data, the auxiliary data describing at least one location of interest in the data, as considered by the user when determining the annotation for the data (in block 602) and training the model using the training data (in block 604). Training the model comprises minimising an auxiliary loss function that compares the at least one location of interest to an output of one or more layers of the model, and minimising a main loss function that compares the annotation for the data as determined by the user to an annotation produced by the model.

Acquiring training data and training the model using the training data in this way was described in detail above with respect to system 100 and the details therein will be understood to apply equally to blocks 602 and 604 of method 600 respectively.

In this way, as described above with respect to system 100, auxiliary data (such as eye-gaze data, gestural data and speech) obtained from a user as the user determines the annotation for the data can be used to improve the training process of the model. As the auxiliary data can be obtained for free, without any additional effort on the part of the human annotator, the training process is also more efficient for the user and potentially more cost effective.

There is also provided a computer program product comprising a computer readable medium, the computer readable medium having computer readable code embodied therein, the computer readable code being configured such that, on execution by a suitable computer or processor, the computer or processor is caused to perform the method or methods described herein. Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other.

An embodiment relating to a computer program product comprises computer-executable instructions corresponding to each processing stage of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A system for training a neural network model, the system comprising:
a memory comprising instruction data representing a set of instructions;
a processor configured to communicate with the memory and to execute the set of instructions, wherein the set of instructions, when executed by the processor, cause the processor to:
acquire training data, the training data comprising: data, an annotation for the data as determined by a user and auxiliary data, the auxiliary data describing at least one location of interest in the data, as considered by the user when determining the annotation for the data; and
train the model using the training data, wherein causing the processor to train the model comprises causing the processor to:
minimise an auxiliary loss function that compares the at least one location of interest to an output of one or more layers of the model; and
minimise a main loss function that compares the annotation for the data as determined by the user to an annotation produced by the model.

2. A system as in claim 1 wherein the auxiliary data comprises eye gaze data and the at least one location of interest comprises at least one location in the data observed by the user when determining the annotation for the data.

3. A system as in claim 2 wherein the eye gaze data comprises one or more of:
information indicative of which portions of the data the user looked at when determining the annotation for the data;
information indicative of the amount of time the user spent looking at each portion of the data when determining the annotation for the data; and
information indicative of the order in which the user looked at different portions of the data when determining the annotation for the data.

4. A system as in claim 1 wherein causing the processor to minimise the auxiliary loss function comprises causing the processor to update weights of the model so as to give increased significance to the at least one location of interest in the data, compared to locations in the data that are not locations of interest.

5. A system as in claim 1 wherein causing the processor to minimise the auxiliary loss function comprises causing the processor to update weights of the model so as to give increased significance to locations of interest considered by the user for longer periods of time compared to locations of interest that are considered by the user for shorter periods of time.

6. A system as in claim 1 wherein causing the processor to minimise the auxiliary loss function comprises causing the processor to update weights of the model so as to give increased significance to locations of interest in the data that are at least one of:
considered during an initial time interval by the user when determining the annotation for the data;
considered during a final time interval by the user when determining the annotation for the data; and
considered a plurality of times by the user when determining the annotation for the data.

7. A system as in claim 1 wherein the auxiliary data comprises an image, image components of the image corresponding to a portion of the data.

8. A system as in claim 7 wherein the image comprises a heat map, and wherein values of image components in the heat map are correlated with whether each image component corresponds to a location of interest in the data and/or a duration that the user spent considering each corresponding location of the data when determining the annotation for the data.

9. A system as in claim 7 wherein causing the processor to minimise an auxiliary loss function comprises causing the processor to compare the image data to an output of one or more convolutional layers of the model.

10. A method as in claim 1 wherein causing the processor to minimise an auxiliary loss function comprises causing the processor to compare the auxiliary data to an output of one or more dense layers of the model.

11. A system as in claim 1 wherein causing the processor to train the model comprises causing the processor to minimise one or more of:
the auxiliary loss function and the main loss function in parallel;
the auxiliary loss function before minimising the main loss function; and
the auxiliary loss function to within a predetermined threshold, after which the model is further trained using the main loss function.

12. A system as in claim 1 wherein the set of instructions, when executed by the processor, further cause the processor to:
calculate a combined loss function, the combined loss function comprising a weighted combination of the main loss function and the auxiliary loss function; and
adjust one or more weights associated with the weighted combination of the combined loss function, so as to change the emphasis of the training between minimising the main loss function and minimising the auxiliary loss function.

13. A system as in claim 1 wherein the model comprises a modified U-Net architecture.

14. A method of training a neural network model, the method comprising:
acquiring training data, the training data comprising: data, an annotation for the data as determined by a user and auxiliary data, the auxiliary data describing at least one location of interest in the data, as considered by the user when determining the annotation for the data; and
training the model using the training data, the training comprising:
minimising an auxiliary loss function that compares the at least one location of interest to an output of one or more layers of the model; and
minimising a main loss function that compares the annotation for the data as determined by the user to an annotation produced by the model.

15. A computer program product comprising a computer readable medium, the computer readable medium having computer readable code embodied therein, the computer readable code being configured such that, on execution by a suitable computer or processor, the computer or processor is caused to perform the method as claimed in claim 14.
